(19) United States
(12) Patent Application Publication
(10) Pub. No.: US 2026/0024379 A1
(43) Pub. Date: Jan. 22, 2026

(54) ELECTRIFIED VEHICLE SUPPORTING PARTIAL BATTERY REPLACEMENT MODE AND METHOD OF CONTROLLING SAME

(71) Applicants: HYUNDAI MOTOR COMPANY, SEOUL (KR); KIA CORPORATION, SEOUL (KR)

(72) Inventor: Yeol Mae Yeo, Hwaseong-si (KR)

(73) Assignees: HYUNDAI MOTOR COMPANY, SEOUL (KR); KIA CORPORATION, SEOUL (KR)

(21) Appl. No.: 18/971,696

(22) Filed: Dec. 6, 2024

(30) Foreign Application Priority Data
Jul. 16, 2024 (KR) 10-2024-0093897

(51) Int. Cl. G07C 5/00; B60L 50/60; B60L 58/12; B60L 58/22; B60W 60/00; G07C 5/08; H01M 10/42; H01M 10/44; H01M 10/48

(52) U.S. Cl. CPC G07C 5/006; B60L 50/60; B60L 58/12; B60L 58/22; B60W 60/00; G07C 5/0825; H01M 10/425; H01M 10/441; H01M 10/482; H01M 2010/4271; H01M 2220/20

(57) ABSTRACT

A method of controlling an electrified vehicle supporting partial replacement of a battery pack including a plurality of unit bodies includes storing cell information about cells of each of the unit bodies when a preconfigured condition is satisfied during driving, determining, when entering a partial battery replacement mode for replacing at least some of the plurality of unit bodies, an average unit body internal resistance for the plurality of unit bodies, based on the stored cell information, and outputting information on the determined average unit body internal resistance via a display device.

### CROSS REFERENCE TO RELATED APPLICATIONS

The present application claims priority to Korean Patent Application No. 10-2024-0093897, filed on Jul. 16, 2024, the entire contents of which is herein for all purposes by this reference.

### BACKGROUND

### 1. Field of the Present Disclosure

The present disclosure relates to an electrified vehicle supporting a mode for partial replacement of a battery pack and a method of controlling the same.

### 2. Description of Related Art

In an electrified vehicle having an electric motor as a drive source, a battery controller (battery management system (BMS)) measures the current, voltage, temperature, etc., of a battery and estimates the remaining capacity (state of charge (SOC)) of the battery, based on the measured value. In addition, when an SOC deviation of a predetermined level or more occurs between battery cells, the battery controller may perform cell balancing by connecting balancing resistors within the battery pack to discharge a cell having a relatively higher voltage.

Meanwhile, a battery is generally configured as a single battery pack with a plurality of modules each containing a plurality of cells. When a battery fails or some of the internal components deteriorate during the operation of an electrified vehicle, battery replacement is generally performed in units of battery packs, and this may cause a heavy burden to a vehicle customer and is environmentally undesirable. Therefore, a method has recently been proposed to solve the problem by performing the replacement in units of modules when there is a malfunction of some component units within the battery pack.

However, when a battery pack is repaired by performing replacement in units of modules, the modules may deteriorate depending on a period or pattern of battery use before the repair, resulting in a deviation of the state of health (SOH) from that of a new module. In this case, a voltage deviation between cells may increase under load conditions, and even under no load conditions, a voltage deviation may occur due to maintenance errors. In addition, when using existing SOC estimation methods such as Coulomb counting or open circuit voltage (OCV) estimation methods, the accuracy of SOC estimation may also decrease due to differences in degradation between modules.

The foregoing described as the background art is intended merely to aid in the understanding of the background of the present disclosure, and is not intended to mean that the present disclosure falls within the purview of the related art already known to those skilled in the art.

### SUMMARY

Various aspects of the present disclosure are directed to providing an electrified vehicle enabling more effective partial battery repair and a control method thereof.

The objects to be achieved in an exemplary embodiment of the present disclosure are not be limited to the above-mentioned object, and other technical objects which are not mentioned may be clearly understood from the following descriptions by those skilled in the art to which the present disclosure pertains.

As a measure to address the technical problem according to an embodiment of the disclosure, a method of controlling an electrified vehicle supporting partial replacement of a battery pack including a plurality of unit bodies may include storing cell information about cells of each of the unit bodies when a preconfigured condition is satisfied during driving, determining, in case of entering a partial battery replacement mode for replacing at least some of the plurality of unit bodies, an average unit body internal resistance for the plurality of unit bodies, based on the stored cell information, and outputting information on the determined average unit body internal resistance via a display device.

For example, the method may further include determining at least one unit body subject to replacement among the plurality of unit bodies.

For example, the determining may include determining an average unit body internal resistance for the remaining unit bodies excluding the unit body subject to replacement among the plurality of unit bodies.

For example, the method may further include outputting information about the at least one unit body subject to replacement.

For example, the method may further include, based on information on the determined average unit body internal resistance, determining whether cell balancing is required when charging is performed on the battery pack after the at least one unit body subject to replacement is replaced.

For example, the method may further include, in case that the cell balancing is required, receiving an input of the maximum work time, and performing the cell balancing based on the maximum work time.

For example, the performing of the cell balancing may include performing the cell balancing by a battery controller in an active or passive manner, or discharging the battery pack by an autonomous controller via autonomous driving.

For example, the discharging of the battery pack via the autonomous driving may be performed in case that the cell balancing of the battery controller is determined to be unable to be completed within the maximum work time.

For example, the preconfigured condition may be satisfied when, in a preconfigured state of charge (SOC) or below, an output equal to or larger than a preconfigured threshold is maintained for a preconfigured period of time or longer.

For example, each of the unit bodies may include a module.

In addition, an electrified vehicle according to an embodiment may include a battery pack including a plurality of unit bodies, a first controller configured to store cell information about cells of each of the unit bodies when a preconfigured condition is satisfied during driving, and in case of entering a partial battery replacement mode for replacing at least some of the plurality of unit bodies, to determine an average unit body internal resistance for the plurality of unit bodies, based on the stored cell information, and a second controller configured to perform control to output information on the determined average unit body internal resistance via a display device.

For example, the electrified vehicle may further include a third controller configured to determine at least one unit body subject to replacement among the plurality of unit bodies.

For example, the first controller may determine an average unit body internal resistance for the remaining unit bodies excluding the unit body subject to replacement among the plurality of unit bodies.

For example, the second controller may perform control to output information about the at least one unit body subject to replacement via the display device.

For example, the third controller may, based on information on the determined average unit body internal resistance, determine whether cell balancing is required when charging is performed on the battery pack after the at least one unit body subject to replacement is replaced.

For example, the first controller may, in case that the cell balancing is required, perform control to receive an input of the maximum work time, and perform the cell balancing based on the maximum work time.

For example, the first controller may perform control to discharge the battery pack via autonomous driving control or control the third controller to perform the cell balancing in an active or passive manner.

For example, the first controller may, in case that the cell balancing through the third controller is determined to be unable to be completed within the maximum work time, perform the autonomous driving control.

For example, the preconfigured condition is satisfied when, in a preconfigured state of charge (SOC) or below, an output equal to or larger than a preconfigured threshold is maintained for a preconfigured period of time or longer.

For example, each of the unit bodies may include a module.

The electrified vehicle according to embodiments provides a partial battery replacement mode to enable more effective battery repair.

In particular, an internal resistance value suitable for application to a module subject for replacement is provided, and cell balancing can be performed automatically after replacement, thereby providing convenience.

Advantageous effects obtainable from the present disclosure may not be limited to the above-mentioned effects, and other effects which are not mentioned may be clearly understood from the following descriptions by those skilled in the art to which the present disclosure pertains.

### BRIEF DESCRIPTION OF THE FIGURES

The above and other aspects, features and advantages of the disclosure will be more apparent from the following detailed description taken in conjunction with the accompanying drawings, in which:

FIG. 1 illustrates an example of a configuration of an electrified vehicle supporting a battery replacement mode according to an embodiment of the disclosure;

FIG. 2 is a flow diagram illustrating an example of a process in which a battery replacement mode is performed according to an embodiment;

FIG. 3 is a flow diagram illustrating another example of a process in which a battery replacement mode is performed according to an embodiment; and

FIG. 4 is a flow diagram illustrating yet another example of a process in which a battery replacement mode is performed according to an embodiment.

### DETAILED DESCRIPTION

Hereinafter, embodiments set forth herein will be described in detail with reference to the accompanying drawings, and the same or similar elements are given the same and similar reference numerals regardless of figure numbers, so duplicate descriptions thereof will be omitted. The terms “module” and “unit” used for the elements in the following description are given or interchangeably used in consideration of only the ease of writing the specification, and do not have distinct meanings or roles by themselves. In addition, in relation to describing the embodiments disclosed in the present specification, when the detailed description of the relevant known technology is determined to unnecessarily obscure the gist of the present disclosure, the detailed description may be omitted. In addition, it should be appreciated that the accompanying drawings are provided only for the sake of easy understanding of the embodiments set forth herein, and the technical idea of the present disclosure is not limited to the accompanying drawings and includes all modifications, equivalents, or alternatives falling within the spirit and scope of the present disclosure.

Terms including an ordinal number such as “a first” and “a second” may be used to describe various elements, but the elements are not limited to the terms. The above terms are used merely for the purpose of distinguishing one element from other elements.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

A unit or a control unit included in names such as a motor control unit (MCU) is merely a term widely used for naming a controller configured to control a specific function, but does not mean a generic function unit. For example, in order to control a function that a control unit is responsible for, each control unit may include a communication device configured to communicate with a sensor or another control unit, a memory configured to store an operation system, a logic command, or input/output information, and at least one processor configured to perform determination, calculation, decision or the like which are required for responsible function controlling.

Hereinafter, with reference to the accompanying drawings, an electrified vehicle supporting a battery replacement mode and a control method thereof according to various embodiments will be described in detail.

An embodiment of the disclosure proposes that, when partial replacement (i.e., repair) is required for at least some of the plurality of unit bodies configuring a battery pack in a vehicle, characteristic information suitable for a unit body to be provided to the battery pack is provided via a partial replacement mode, and that even cell balancing is performed automatically when the replacement of the unit body is completed based on the characteristic information.

For example, in the partial replacement mode, a unit body to be replaced may be a module.

In addition, when a module is assumed to be a unit body to be replaced, the characteristic information may be an average internal resistance (IR) of modules in a battery pack. It is common for the internal resistance of a module to increase as each module deteriorates in response to repeated charging and discharging of the battery pack. When the battery pack needs to be repaired by partial replacement in units of modules, a new module installed to replace an abnormal module may have a different degree of degradation from the remaining modules, and this difference may result in different internal resistance values between them. Therefore, in case that an internal resistance corresponding to the average internal resistance values of the remaining modules excluding the abnormal module is pre-applied to a new module and then installed in the battery pack, the new module may also have an internal resistance value corresponding to that of the existing modules, thereby reducing problems caused by an SOH deviation.

Furthermore, even if the SOH deviation between modules is reduced by internal resistance matching of a new module, the SOC after repair may be different for each module. To this end, according to the embodiments, it is determined whether cell balancing is required during a charging process after repair, and when cell balancing is determined to be required, cell balancing control including autonomous driving may be automatically performed.

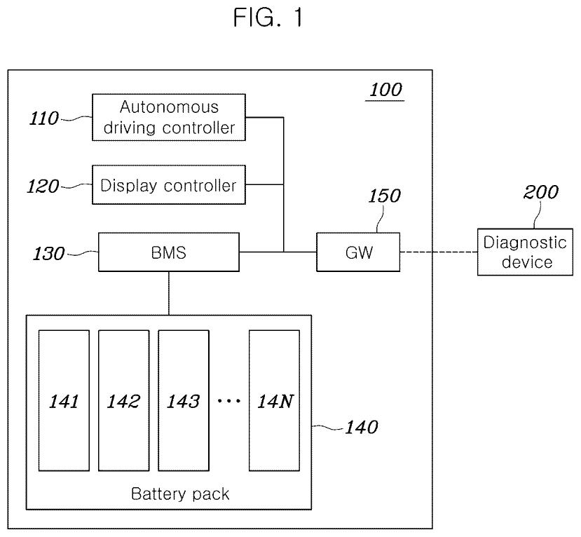

FIG. 1 illustrates an example of a configuration of an electrified vehicle supporting a battery replacement mode according to an embodiment of the disclosure.

Referring to FIG. 1, an electrified vehicle 100 according to an embodiment may include an autonomous driving controller 110, a display controller 120, a battery controller (battery management system (BMS)) 130, a battery pack 140, and a gateway (GW) 150.

FIG. 1 mainly shows elements associated with an embodiment, and it is obvious that actual implementations of electrified vehicles may include more or fewer elements than those shown in FIG. 1. For example, the electrified vehicle 100 may further include elements such as a drive source such as an electric motor, and a motor controller (MCU) that controls an electric motor.

Hereinafter, respective elements are described.

First, the autonomous driving controller 110 may generate control commands, such as steering angle, torque required for a drive source, torque required for braking, and the like, required for operation of the vehicle based on situational information surrounding the vehicle obtained by various sensors (not shown). In particular, in connection with an embodiment, the autonomous driving controller 110 may store status information of the battery pack 140 when a preconfigured condition is satisfied during driving, and may determine a value of the average internal resistance of the modules in the battery pack 140 based on the stored information.

Here, the average internal resistance value may be the average internal resistance value of normal modules, excluding the internal resistance value of the abnormal module that needs to be replaced. Further, the preconfigured condition may indicate a case in which a vehicle has been driven for “c” seconds or more at an output of “b” W when the SoC has reached “a” % or less during previous driving. Here, each of the variables of “a”, “b”, and “c” may be a preconfigured value for each vehicle type by tests and the like. More specifically, the variable “a” is preferably selected as the starting point of an SOC interval in which a voltage deviation between cells increases (e.g., a value of 10 or less). In addition, the variable “b” may be selected as a high-load output, e.g., an output targeting a current value greater than or equal to 1 C with respect to a cell. Furthermore, the variable “c” is preferably configured as a time value (e.g., 2 or greater) that is valid for measuring the internal resistance value.

Each of the variables of “a”, “b”, and “c” uses the initially stored value once during one driving cycle (DC), and may not be updated when the aforementioned preconfigured condition is not satisfied when driving again after the end of driving cycle (IG off).

The internal resistance value may be determined by calculating a trend line for the change in voltage (V) and current (I) for each cell according to the “b” W output for “c” seconds, but this is an example and is not necessarily limited thereto. The method of determining internal resistance using a trend line will be apparent to those skilled in the art and is not described in detail.

In addition, when the BMS 130 determines that cell balancing is required after partial replacement of the battery pack 140 is achieved, the autonomous driving controller 110 may determine and execute necessary operations depending on the degree of cell balancing required. For example, when the BMS 130 performs cell balancing by SOC redistribution between modules or by a passive manner (i.e., discharge using internal resistors for cell balancing), the start-up may be controlled to be an ON state so that the BMS 130 may connect the charge/discharge lines to only a specific module and perform cell balancing. As another example, when cell balancing requires a predetermined level of discharge or more, the autonomous driving controller 110 may autonomously drive on a road around a workplace (e.g., a repair shop) where partial battery replacements are performed to allow cell balancing by discharge to be performed. When the cell balancing is completed by discharge via driving, the autonomous driving controller 110 may cause the vehicle 100 to end driving on the surrounding road and return to the workplace. In this case, the surrounding road may be a route selected by the autonomous driving controller 110 based on the amount of discharge required, or may be a route pre-selected for each workplace.

The display controller 120 may control the display device so that desired output information is output in a preconfigured form. For example, the display controller 120 may include, but is not necessarily limited to, an audio/video/navigation (AVN) controller, a cluster controller, and the like. Further, in case that the display controller 120 is an AVN controller, the display device may be a display of an AVN system, and in case that the display controller 120 is a cluster controller, the display device may be a display disposed in a cluster.

The BMS 130 may determine the status of the battery pack 140 and internal components thereof. For example, the BMS 130 may determine a voltage, current, SOC, SOH, temperature, and the like for each cell of the battery pack 140, and may determine whether cell balancing is required. Depending on the implementation, the BMS 130 may perform, instead of the autonomous driving controller 110, a function of determining the average internal resistance value of the autonomous driving controller 110 described above.

The battery pack 140 may include a plurality (N) of modules 141, 142, 143, and 14N, and each of the plurality of modules 141, 142, 143, and 14N may include a plurality of cells.

The gateway 150 may provide a connection interface between each of the controllers 110, 120, and 130 connected via a vehicle network (e.g., CAN, CAN-FD, LIN, Ethernet, etc.) and an external device (here, a diagnostic device 200). For example, the connection interface with the diagnostic device 200 may include, but is not necessarily limited to, diagnostic communications such as OBD-II. For example, according to other implementations, the gateway 150 may be replaced by another communication device capable of short-range wireless communication with the diagnostic device 200.

The diagnostic device 200 is an external component of the vehicle 100, and may be connected to the gateway 150 via a diagnostic communication interface or may be connected to a wireless communication module (not shown) of the vehicle 100 via a short-range wireless communication interface. When the diagnostic device 200 is communicatively connected to the vehicle 100, the diagnostic device 200 may transmit and receive signals defined for general diagnostic communications to and from the vehicle 100, as well as transmit commands to the vehicle 100 to enter or exit a partial battery replacement mode according to an embodiment.

Hereinafter, a process of performing a partial battery replacement mode based on the above-described configuration of the vehicle 100 according to an embodiment is described in detail. For convenience, the unit being replaced in the partial battery replacement mode is assumed to be a module, and the mode will be referred to as a “battery module replacement mode”.

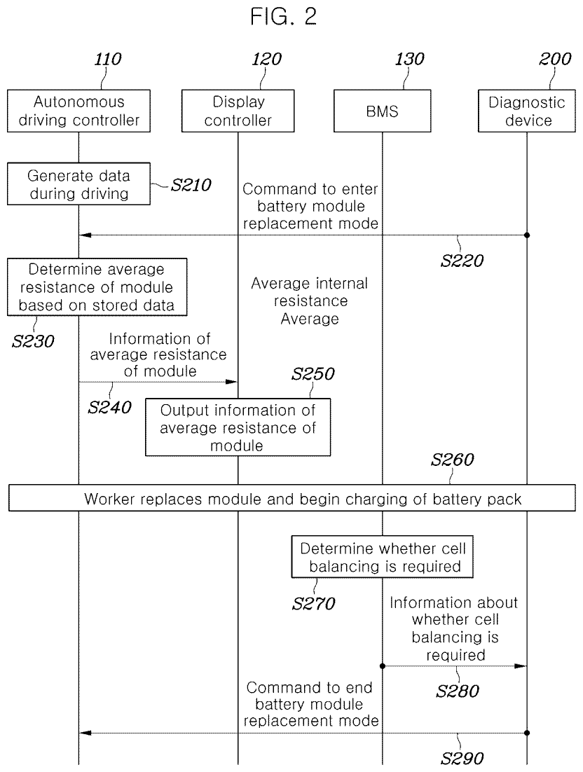

FIG. 2 is a flow diagram illustrating an example of a process in which a battery replacement mode is performed according to an embodiment.

Referring to FIG. 2, an autonomous driving controller 110 may store data including a value for the change in voltage and current for each cell (operation S210) when the aforementioned preconfigured condition is satisfied during driving (i.e., driving for “c” seconds or more at an output of “b” W when the SoC has reached “a” % or less). In other words, the autonomous driving controller 110 may store a voltage and current change history for each cell based on the output of “b” W for “c” seconds.

When a diagnostic device 200 is connected to the vehicle 100 and transfers a command to enter the battery module replacement mode (operation S220), the autonomous driving controller 110 may determine an average internal resistance of a module, based on the finally stored data (operation S230) and transfer the determined average internal resistance of a module to a display controller 120 (operation S240). As described above, the average internal resistance of a module may be an average value of the internal resistances of respective remaining modules except a module subject to replacement, and may be obtained by applying a trend line calculation technique based on cell voltage and current variation, but is not necessarily limited thereto. On the other hand, until a command to enter the battery module replacement mode is received from the diagnostic device 200 (i.e., until a maintenance worker initiates battery maintenance), the need to replace a module of a battery pack 140 may be notified of in advance to a user of the vehicle 100 or a maintenance worker in a preconfigured form. In other words, an operation of determining whether there is abnormality in each module (not shown), an operation of outputting, from the vehicle 100, information indicating that replacement of at least some modules in which an abnormality is detected is required (not shown) may be performed before operation S220.

The need for module replacement may be determined based on a result of diagnostics on the battery pack 140 by the BMS 130, and the notification may take the form of outputting battery abnormality information via a display device controlled by the display controller 120, outputting battery abnormality information via a telematics service, a fault code transmitted to the diagnostic device 200 when the diagnostic device 200 is connected, etc., but this is only an example and is not necessarily limited thereto. Of course, the need for a module replacement may also be determined by a perception of a maintenance worker during a maintenance process, such as a visual inspection. In addition, the notification of the need for module replacement may include information about a module to be replaced.

The display controller 120 may output the module average resistance information via a display device controlled by the display controller itself (operation S250). The worker may remove the module to be replaced from the battery pack 140, install a new module having a matched internal resistance value on the battery pack 140 by referring to the output average resistance information, and then connect a charger to the vehicle 100 to charge the battery pack 140 (operation S260).

In this case, among new modules manufactured to have different internal resistance values, a module having an internal resistance value that matches the average module resistance value output to the display device may be selected as the new module being installed. On the other hand, the new module that the worker installs may have an additional internal resistance equal to the difference between the nominal internal resistance value of the new module and the average module resistance value output to the display device. However, this method of preparing a new module having a matched internal resistance is exemplary and not necessarily limited thereto.

The BMS 130 may monitor the voltage of all cells of the battery pack 140 in which a module has been replaced as the charging progresses, and estimate the SOC based thereon to determine whether cell balancing is required based on cell-to-cell SOC deviations (operation S270). For example, the BMS 130 may determine to enter cell balancing when an SOC deviation of a preconfigured percentage (e.g., 1%) or greater occurs in the cell-specific SOC estimated during the charging process.

The information about whether cell balancing is required may be transferred to the diagnostic device 200 (operation S280), and when the maintenance worker identifies the diagnostic device 200 and determines that cell balancing is not required, the battery module replacement mode may be ended. Accordingly, a command to end the battery module replacement mode may be transferred to the autonomous driving controller 110 (operation S290). Thereafter, the maintenance worker may transfer the vehicle 100 to a customer.

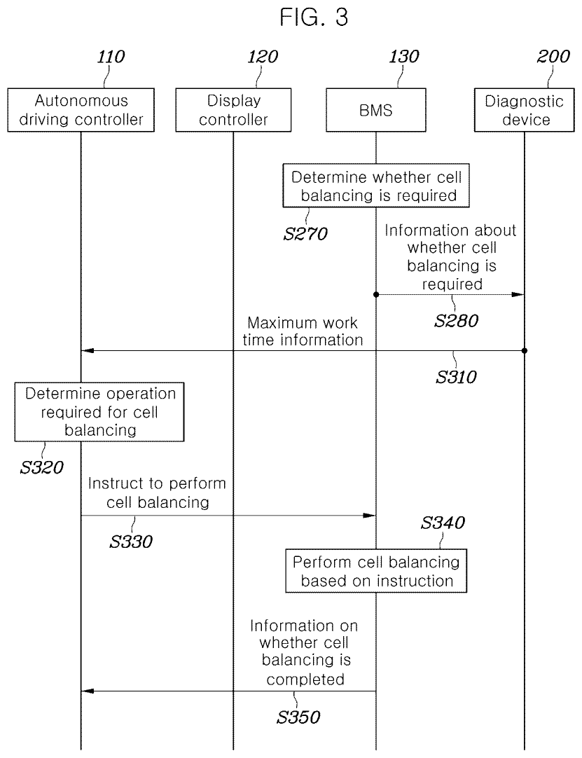

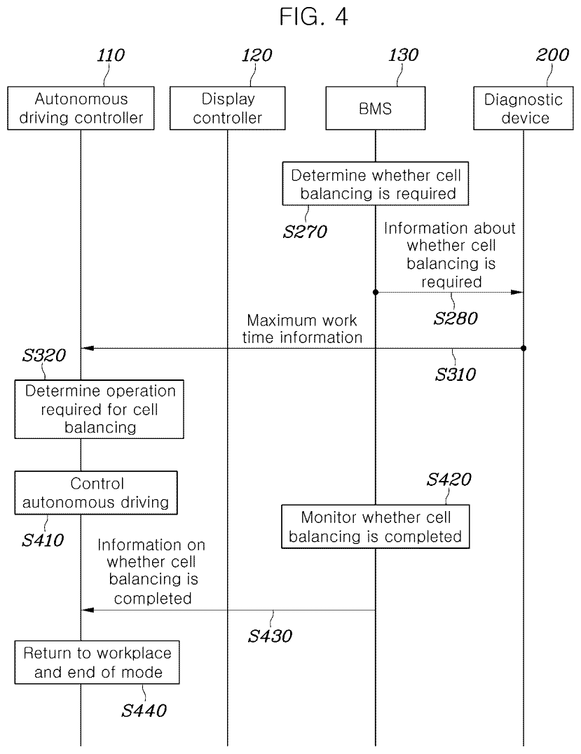

In FIG. 2, a case where cell balancing is determined not to be required after battery module replacement is shown. Conversely, there may be cases where cell balancing is determined to be required after module replacement. In such cases, the process of performing cell balancing is described with reference to FIGS. 3 and 4.

FIG. 3 is a flow diagram illustrating another example of a process in which a battery replacement mode is performed according to an embodiment.

It is assumed that FIG. 3 illustrates a process after operation S260 of FIG. 2, and the description of operations S210 to S260 is omitted.

Referring to FIG. 3, as charging of the battery pack 140 proceeds after the module replacement, the battery controller (BMS) 130 may determine whether cell balancing is required (operation S270). When cell balancing is determined to be required, the BMS 130 may transmit information indicating that cell balancing is required to the diagnostic device 200.

The maintenance worker may identify that cell balancing is required, and may input maximum work time information to the diagnostic device 200. The maximum work time information may refer to, but is not necessarily limited to, a maximum amount of time that may be spent on the cell balancing operation and may be input based on the maintenance worker's work schedule.

The autonomous driving controller 110 may determine an operation required for cell balancing by considering the maximum work time included in the maximum work time information (operation S320). For example, in case that the maximum work time is sufficient for the BMS 130 to perform cell balancing by itself in a passive or active manner using components within the battery pack 140 (e.g., internal resistors for cell balancing, internal switches, internal capacitors, etc.), the autonomous driving controller 110 may instruct the BMS 130 to perform cell balancing (operation S330) and control the vehicle 100 to maintain the power state required for cell balancing. In order to determine whether the maximum work time is sufficient, the autonomous driving controller 110 may obtain, from the BMS 130, the SOC deviation information, cell-specific SOC information, and the like, determined in operation S270.

The BMS 130 may perform the cell balancing according to the instruction from the autonomous driving controller 110 (operation S340), and may transfer information on whether cell balancing is completed to the autonomous driving controller 110 when the maximum work time has elapsed or when the cell balancing is completed. Depending on the implementation, the autonomous driving controller 110 or the BMS 130 may also transfer the information on whether cell balancing is completed to the diagnostic device 200.

In FIG. 3, a case is illustrated where the maximum work time is determined to be sufficient to perform self-cell balancing of the BMS 130. In contrast, the control process when the maximum work time is less than the time required to perform self-cell balancing of the BMS 130 is shown in FIG. 4.

FIG. 4 is a flow diagram illustrating yet another example of a process in which a battery replacement mode is performed according to an embodiment.

It is assumed that FIG. 4 illustrates a process after operation S260 of FIG. 2 in a manner similar to that of FIG. 3, and operations S270 to S310 are also similar to those of FIG. 3, and thus a description of operations S210 to S310 is omitted.

Referring to FIG. 4, the autonomous driving controller 110 may determine an operation required for cell balancing by considering the maximum work time included in the maximum work time information (operation S320). For example, in case that the maximum work time is determined to be insufficient for the battery controller (BMS) 130 to perform cell balancing by itself in a passive or active manner using components (e.g., internal resistors for cell balancing, internal switches, internal capacitors, etc.) within the battery pack 140 (i.e., when it is determined that cell balancing by the BMS 130 is unable to be completed within the maximum work time), or in case that a battery discharge of a preconfigured level or higher is required, the autonomous driving controller 110 may determine to perform cell balancing by driving.

Accordingly, the autonomous driving controller 110 may perform autonomous driving control for cell balancing (operation S410). As described above, the autonomous driving control may take the form of driving on a road around a workplace (e.g., a repair shop) where a partial battery replacement is being performed.

When the cell balancing is completed due to the discharge caused by driving, according to the monitoring of the BMS 130 (operation S420), the BMS 130 notifies the autonomous driving controller 110 of the completion of the cell balancing (operation S430), and the autonomous driving controller 110 may end the battery module replacement mode after the vehicle 100 returns to the workplace after the vehicle completes driving around the neighborhood (operation S440).

Conventionally, in order to perform cell balancing after battery repair, a worker is required to manually operate the vehicle and a function thereof or perform tasks that require the use of equipment. However, according to the embodiments described above, the autonomous driving controller automatically performs cell balancing. Therefore, maintenance costs can be reduced. In addition, the consistency of cell-to-cell voltage deviation after module replacement may be immediately identified by the autonomous driving, and cell balancing can facilitate subsequent SOC estimation to reduce SOC estimation errors.

The present disclosure as described above may be implemented as codes in a computer-readable medium in which a program is recorded. The computer-readable medium includes all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. Therefore, the above detailed description should not be construed in a limitative sense, but should be considered in an illustrative sense in all aspects. The scope of the present disclosure shall be determined by reasonable interpretation of the appended claims, and all changes and modifications within an equivalent range of the present disclosure fall within the scope of the present disclosure.

While the present disclosure has been described with reference to the accompanying drawings, it will be apparent to those skilled in the art that various changes and modifications can be made without departing from the spirit and scope of the present disclosure without being limited to the exemplary embodiments disclosed herein. Accordingly, it should be noted that such alternations or modifications fall within the claims of the present disclosure, and the scope of the present disclosure should be construed on the basis of the appended claims.

1. A method of controlling an electrified vehicle supporting partial replacement of a battery pack including a plurality of unit bodies, the method comprising:
storing, by a first controller, cell information about cells of each of the plurality of unit bodies in response to a preconfigured condition being satisfied during driving;
when a partial battery replacement mode for replacing at least some of the plurality of unit bodies is initiated, determining an average unit body internal resistance for the plurality of unit bodies, based on the stored cell information; and
outputting, by a second controller, information on the average unit body internal resistance via a display device.

2. The method of claim 1, further comprising determining at least one unit body subject to replacement among the plurality of unit bodies.

3. The method of claim 2, wherein determining an average unit body internal resistance comprises determining the average unit body internal resistance for remaining unit bodies excluding the at least one unit body subject to replacement among the plurality of unit bodies.

4. The method of claim 2, further comprising outputting information about the at least one unit body subject to replacement.

5. The method of claim 2, further comprising, based on information on the determined average unit body internal resistance, determining whether cell balancing is required when charging is performed on the battery pack after the at least one unit body subject to replacement is replaced.

6. The method of claim 5, further comprising:
when the cell balancing is required, receiving an input of a maximum work time; and
performing the cell balancing based on the maximum work time.

7. The method of claim 6, wherein performing the cell balancing comprises:
performing the cell balancing by a battery controller in an active or passive manner; or
discharging the battery pack by an autonomous controller via autonomous driving.

8. The method of claim 7, wherein the discharging the battery pack via the autonomous driving is performed when the cell balancing of the battery controller is determined to be unable to be completed within the maximum work time.

9. The method of claim 1, wherein the preconfigured condition is satisfied when, in a preconfigured state of charge (SOC) or below, an output equal to or larger than a preconfigured threshold is maintained for a preconfigured period of time or longer.

10. The method of claim 1, wherein each of the plurality of unit bodies comprises a module.

11. An electrified vehicle comprising:
a battery pack including a plurality of unit bodies;
a first controller configured to store cell information about cells of each of the plurality of unit bodies in response to a preconfigured condition being satisfied during driving and, when entering a partial battery replacement mode for replacing at least some of the plurality of unit bodies, the first controller is configured to determine an average unit body internal resistance for the plurality of unit bodies, based on the stored cell information; and
a second controller configured to output information on the determined average unit body internal resistance via a display device.

12. The electrified vehicle of claim 11, further comprising a third controller configured to determine at least one unit body subject to replacement among the plurality of unit bodies.

13. The electrified vehicle of claim 12, wherein the first controller is further configured to determine an average unit body internal resistance for remaining unit bodies excluding the unit body subject to replacement among the plurality of unit bodies.

14. The electrified vehicle of claim 12, wherein the second controller is further configured to output information about the at least one unit body subject to replacement via the display device.

15. The electrified vehicle of claim 12, wherein the third controller is further configured to, based on information on the determined average unit body internal resistance, determine whether cell balancing is required when charging is performed on the battery pack after the at least one unit body subject to replacement is replaced.

16. The electrified vehicle of claim 15, wherein the first controller is further configured to, when the cell balancing is required, receive an input of a maximum work time and perform the cell balancing based on the maximum work time.

17. The electrified vehicle of claim 16, wherein the first controller is further configured to discharge the battery pack via autonomous driving control, or to control the third controller to perform the cell balancing in an active or passive manner.

18. The electrified vehicle of claim 17, wherein the first controller is further configured to, when the cell balancing through the third controller is determined to be unable to be completed within the maximum work time, perform the autonomous driving control.

19. The electrified vehicle of claim 11, wherein the preconfigured condition is satisfied when, in a preconfigured state of charge (SOC) or below, an output equal to or larger than a preconfigured threshold is maintained for a preconfigured period of time or longer.

20. The electrified vehicle of claim 11, wherein each of the plurality of unit bodies comprises a module.
